(19) United States
(12) Patent Application Publication
(10) Pub. No.: US 2017/0197744 A1
(43) Pub. Date: Jul. 13, 2017

(54) CONTINUOUS PROCESS AND SYSTEM FOR THE PASTEURIZATION OR STERILIZATION OF FOODSTUFFS IN A RIGID CONTAINER FOLLOWED BY THE DEEP-VACUUM SEALING THEREOF BY ROTARY STEAM INJECTION AND HOMOGENEOUS RAPID COOLING

(71) Applicant: SODETECH, LA TESTE DE BUCH (FR)

(72) Inventors: JEAN LARROCHE, PUJOLS (FR); BRIGITTE LARROCHE, PARIS (FR)

(21) Appl. No.: 15/399,580

(22) Filed: Jan. 5, 2017

(30) Foreign Application Priority Data
Jan. 7, 2016 (FR) 16 50122

(51) Int. Cl. B65B 31/02; B65B 55/10; A23L 3/18; B65B 7/28; B65B 25/00; B65B 63/08; B65B 55/18; B65B 3/30

(52) U.S. Cl. CPC B65B 31/028; B65B 55/18; B65B 55/10; B65B 3/30; B65B 7/28; B65B 25/001; B65B 63/08; A23L 3/18; A23V 2002/00

(57) ABSTRACT

A method and a system of devices for continuous sterilization or pasteurization of foodstuffs contained in specific rigid containers, followed by continuous deep-vacuum sealing of the containers. The evacuation is obtained by rotary steam injection between the lids and the receptacles followed by sealing of the containers and cold showering that brings about condensation of the steam inside the container and consequently a deep vacuum. This results in a long-lasting deep-vacuum preservation of the food under organoleptic and nutritional quality conditions with a drastic reduction in the cooling time of the containers after sterilization or pasteurization, The reduction in cooling time is obtained by a low-temperature boiling under vacuum, which boiling is homogeneously distributed throughout the whole of the container. It is particularly suitable for pasty or liquid products or products in chunks included in a liquid or pasty mixture.

### FIELD OF THE INVENTION

The present invention relates to the agri-food field, and more particularly to the rigid-container packaging of foodstuffs.

The present invention relates more particularly to a process and a system for the continuous sterilization or pasteurization of foodstuffs followed by the continuous deep-vacuum sealing of said container for a long-lasting deep-vacuum preservation of the food under exceptional organoleptic and nutritional quality conditions, by means of a drastic reduction in the cooling time of the containers after sterilization. It implements the use of a particular container, designed to be sealed under deep vacuum. It is suitable for pasty or liquid products or products in chunks included in a liquid or pasty mixture.

In the rest of the present document, the term ‘container’ will denote the assembly formed by a “receptacle” and its “lid”.

### PRIOR ART

Canning processes, through historically important, are gradually being replaced in part by flash freezing, due to the organoleptic and nutritional drawbacks of overcooking arising from the fact that it is not possible to cool the cans quickly enough after the sterilization thereof. Progress has nevertheless been made with vacuum metal packaging, admittedly with limited vacuum levels.

U.S. Pat. No. 1,931,911 describes a process for vacuum packaging of food products in a container sealed by a lid without fastening means. This process is unsuitable for continuous mass production.

French patent FR 2 385 607 describes a process in which steam is injected between the lid and the receptacle, then the sealed container is introduced into an autoclave placed under excess pressure by injection of compressed air during the pasteurization or sterilization, in order subsequently to be gradually cooled and brought back to atmospheric pressure. Unfortunately, since the mixture of air and steam is heterogeneous, the temperature in the autoclave is also heterogeneous. Moreover, this process does not make it possible to sufficiently evacuate the oxygen from the container. Finally, the sterilization time necessary for obtaining preservation safety necessarily leads to an excessive cooking of the product aggravated by the excessively slow cooling that the text recommends and which would lead to a degradation of the product by caramelization of the sugars or/and degradation of the flavours and of the colour by the Maillard reaction.

French patent FR 2 686 059 resorts to the same process and means as the patent mentioned in the previous paragraph, and is subject to the same impossibilities and drawbacks.

European patent EP 79101660 (SCHWERDTEL) proposes an apparatus for the vacuum sealing of cans with a lid that comprises a first step of holding the lid on the end of the can by the vacuum obtained in a chamber and a second step, in another chamber, of seaming of the lid. However, document EP 79101660 (SCHWERDTEL) does not tackle the use of deep vacuum in the preservation process and addresses the reinjection of gas.

Patent EP 2 106 219 is also known that describes a packaging system and process that takes up the elements of a previous patent EP 0 715 587 and enables the vacuum packaging of aqueous food products in a rigid receptacle sealed by a flexible lid. The receptacle is heated under a partial vacuum in order to bring the liquid to boiling so that the steam generated expels the other gases from the receptacle through the unsealed opening, then the receptacle is sealed. Unfortunately, considering the chaotic emission of the gases, a small amount of air always remains and the deep vacuum is not achieved, the best proof being that this process does not require a very rigid container, as clearly stated by the previous version of the patent EP 0 715 587.

French patent FR 2 829 106, by the inventors of the present invention, effectively makes it possible to achieve a deep vacuum and is applied to containers having a very high resistance to vacuum, such as the containers described by the same inventors in the patent. However, the process described requires the containers to pass through a sterilization or pasteurization phase after evacuation.

European patent EP 2 226 252 describes a process for the continuous vacuum packaging of pasteurized and/or sterilized food products. However, this European patent remains imprecise as regards the vacuum level achieved since it stipulates precisely that the vacuum level achieved should not exceed 950 mbar throughout the process and does not specify how or if such a vacuum level can be achieved, or how the sterile transfer can be guaranteed between the food preparation apparatus and the canning operation.

Finally, European patent EP 2 357 136 describes a steam and cold-water injection head for the continuous vacuum packaging of food products that can be sterilized or pasteurized in a rigid receptacle such as that described in patent EP 2 226 252. Patent EP 2 357 136 also describes a process for using said head in which the receptacle receives a ready-to-eat prepared product, previously degassed, pasteurized or sterilized at high temperature.

Unfortunately, the jets of steam proposed in document EP 2 357 136 are disordered and do not succeed in flushing all the air from the required zones, patent EP 2 357 136 mentioning a relative vacuum close to 850 mbar, which is 100 mbar less than the performance that the present invention proposes, i.e. a lowering of the boiling temperature in the container sealed under deep vacuum from 55° C. to 37° C., i.e. a considerable lengthening of the boiling range and therefore of the range of rapid cooling of the product linked to the latent heat of evaporation/condensation of the water. Patent EP 2 357 136 does not specify either how the sterile transfer can be guaranteed between the food preparation apparatus and the canning operation.

By improving the inventions that are the subjects of European patents EP 2 226 252 and EP 2 357 136, the same inventors propose means that solve the problems stated previously by improving the degassing of the products and therefore the vacuum level in order to shorten the total cooking time, and moreover propose means for guaranteeing the sterility of the products throughout the process, and for obtaining a rapid and homogeneous cooling.

None of the patents previously cited make it possible to carry out a deep-vacuum sealing after pasteurization or sterilization, which has the effect of adding, to the initial cooking of the ready meals, a second quite destructive cooking followed by too long a cooling during which the cooking continues as long as the temperature has not dropped below 68° C. at the core of the product, which makes the packaging of certain pasty products impossible beyond small capacities, such as purees and in particular purees of delicate vegetables which, after sterilization in an autoclave, undergo a caramelization at the centre of the cans, or even a browning and a destruction of the vitamins and flavours contained in the products.

Deep vacuum is defined here as a level of absolute partial pressure of oxygen of at most 10 mbar inside the container measured at 4° C. In order to guarantee this level of vacuum after three years, it is essential that the initial evacuation take place gradually in order to prevent the cells in the food from bursting and make it possible to achieve 5 mbar of absolute partial pressure of oxygen inside the container at the end of the process, measured at ambient temperature.

The heating and cooling times of the packaged food can be shortened considerably using the heat transfers enabled by the latent heat of vaporization/condensation of the water which represents 2269 kjoules per gramme of water vaporized or condensed, i.e. 542 kcal per gramme of water vaporized or condensed.

### SUMMARY OF THE INVENTION

The present invention relates to a process, a system of devices and novel devices for the sterilization or pasteurization of foodstuffs followed by the evacuation and sealing under deep vacuum of said container for a long-lasting vacuum preservation of the food under exceptional organoleptic and nutritional quality conditions. It implements the use of a particular container, designed to be sealed under deep vacuum with no means for fastening the lid to the receptacle other than the vacuum, such as those means presented in the patent EP 2 502 685—“Method for forming the wall of the opening of a metal receptacle or packaging, device for said purpose and packaging or receptacle obtained”. These containers have an elastic seal at the periphery of the lid on the inner face thereof.

It is suitable for pasty or liquid products or products in chunks included in a liquid or pasty composition.

The present invention, by using various essential existing pieces of equipment and by introducing modifications of devices, combinations of devices and novel operations, enables a long-lasting preservation of food under deep vacuum in a rigid container by reaching an absolute pressure of less than 24 mbar at least immediately after preserving and cooling to 4° C., which represents a drop in the boiling temperature of the water to 26° C. in the container and therefore a lengthening of the range in which it is possible to benefit from the advantages of the phase change and latent heat of water (2269 kjoule/g or 542 kcal/g at boiling), the latent heat remaining relatively constant in the pressure range considered, and a lengthening of the duration of protection of the foodstuffs from oxygen with a guarantee that a residual absolute partial pressure of oxygen of less than 10 mbar remains after 3 years, the customary maximum storage time of cans.

The present invention proposes, overall, to increase the vacuum level in the container and to exploit this deep vacuum not only to bring about the very rapid cooling of the food after sealing, but also to better preserve the food, and finally to improve the hold of the lid at its opening.

These methods make provision in particular for bringing about an initial differential pressure between the inside of the container and the atmospheric pressure, at least of the order of 980 mbar, when the atmospheric pressure is at 1014 mbar, by abruptly evacuating the container by injection of superheated steam, hermetic sealing, then cold shower applied to the sterilely pre-filled container.

With the process that is the subject of the invention, a better preservation is obtained in the food substances of the elements thereof, such as the vitamins, flavours and fats, which do not have to suffer the impairment of the residual oxygen customarily contained in the products packaged by prior techniques.

This process makes it possible, for liquid or pasty products or products in chunks with sauce, in particular ready meals, to considerably reduce the cooling time after sealing, owing to the fact that all the heat exchanges take place at saturation vapour pressure, and that liquid/vapour phase changes (latent heat of vaporization/condensation of water=2269 kjoule/g or 542 kcal/g) are therefore benefited from, which accelerate the heat transfers between the food, the walls of the can and the sterilizing autoclave.

For this purpose, the present invention relates, in its most general meaning, to a process for the continuous deep-vacuum pasteurization or sterilization of food products in a rigid container, the sealing of the receptacle portion of said container having to be carried out by a metal lid free of fastening means and provided with an elastic seal that ensures a bond between the receptacle and the lid by means of the vacuum, comprising the following steps:
degassing of the ready-to-be-packaged product;
pasteurization or sterilization of the product;
cooling of the product in order to reach the filling temperature;
sterilization and initial degassing of the receptacles, then transfer of said receptacles into a first chamber, with no break in sterility or introduction of non-condensable gases;
a step during which the product is introduced, measured out and filled in the receptacles in a first chamber maintained under a superheated steam atmosphere, the filling stopping when around the last centimetre of the receptacle is reached, so as to leave a suitable space, having a sufficient volume so that, when the time comes and under certain conditions, the condensation of the superheated steam makes it possible to obtain the target vacuum;
exit of the receptacle filled with food and steam from said first chamber and entry of said receptacle filled with food and steam into a separate second chamber, also maintained under a superheated steam atmosphere where the receptacle is positioned while waiting for its lid;
a step during which the lids from a tubular dispensing magazine, after having been disinfected beforehand or being disinfected during the dispensing operation, are separated and, after their seal has optionally been softened, are introduced into the second chamber and each deposited on a receptacle filled with food, said lids crossing, on their way, a stream of superheated steam exiting the second chamber toward the lid-dispensing magazine;
a step during which each lid is lifted up from its receptacle in order to inject superheated steam between them;
a step during which the receptacle and the lid are pressed against one another to bring the flexible seal of the lid into contact with the rounded edge of the opening of the receptacle, this sealing making it possible to completely isolate from the outside a space referred to here as the “vacuum chamber”;
stopping the injection of steam and showering cold water onto the lid of the receptacle in order to cool it and ensure the condensation of the steam located in the vacuum chamber, which then gives rise to a negative pressure in the container relative to the atmospheric pressure, said negative pressure being sufficient to guarantee that the receptacle and the lid are solidly joined; and
discharging of the container under vacuum to a cooling tunnel where the cooling is continued until the temperature has reached ambient temperature, the cold showering having to be continued as long as the temperature in the product has not dropped below the cooking temperature of the food lying at around 68° C.

Preferably, said process also comprises a step of injecting superheated steam into the empty receptacles before the filling thereof in order to further improve the degassing by avoiding trapping air bubbles below pasty products during the filling thereof.

Advantageously, said process comprises several steps that consist in eliminating all possible sources of non-condensable gases, from the preparation of the product up to the sealing of the container, including when the receptacles are filled, so as to ultimately guarantee a deep vacuum in said container.

According to one embodiment, the sterilization and the degassing operations performed at the time of the sterilization of the receptacles, the filling of the receptacle and the sealing thereof are carried out by injection of superheated steam at more than 130° C. by imposing a rotary movement on the steam in the spaces in question, of whirlwind or vortex type, capable of eliminating any trace of air in a very limited time and of replacing it exclusively with superheated steam capable, during the cooling thereof and the condensation thereof, of causing the container to be placed under said deep vacuum, the steam being injected at a temperature, a flow rate and for a time that are suitable for enabling the sterilization of the zones in question.

Advantageously, the sterilization and the initial degassing of the receptacles are carried out by presentation of the receptacles, with the opening at the bottom, and injection of superheated steam inside the receptacle, the operation then having to take place in the free atmosphere so that the air can escape from the receptacle and so that the superheated steam, which is lighter than air, remains trapped in the receptacle. In this case, an operation for turning over the receptacle takes place prior to the filling thereof this turning over having to be carried out in a separate chamber maintained under a slight overpressure of superheated steam.

According to one embodiment, said process comprises a step of continuously creating, in the packaged containers, thermodynamic conditions necessary so that all the heat exchanges in the container take place at the boiling point and condensation point, making it possible to exploit the latent heat of vaporization of the water in order to discharge the heat from the container.

Advantageously, said process implements a homogeneous boiling of the product, said boiling being normal for materials containing water and placed under the envisaged vacuum, which makes it possible to continuously impose a homogeneous cooling of the food in the already sealed containers.

The present invention also relates to a system for the continuous deep-vacuum pasteurization or sterilization of food products, comprising:
means for degassing the loose product, these means possibly being either an evacuation system, or a cooking system that naturally induces the degassing, or a vacuum cooking;
means for initial sterilizing and degassing of the receptacles;
means for sterilizing and cooling the loose product, said cooling means being placed at the outlet of said sterilizing means;
means for separating and disinfecting the lids, using the superheated steam as disinfecting means, this steam inducing a degassing of the surroundings of the lid, which contributes to the degassing of the whole of the system, and an optionally necessary softening of the seals of the lids;
filling means that optionally enable the discharging of the non-condensable gases in the receptacle, and that in any case enable the measuring out and sterile filling of the food into the receptacle, said filling means possibly being installed in series on a filling line;
means that simultaneously enable the handling of the lids, the injection of steam, the sealing of the food-filled receptacles and the cooling of the containers by cold showering, said means also being referred to as “sealing head”;
a first chamber, located upstream of the entire vacuum sealing system and including means for positioning the receptacles and also a filling line, said chamber having to be maintained in a state of optimal sterility by the initial injection of superheated steam from the start of the process, then maintained under steam by a slight overpressure of steam which requires a stream leaving the chamber toward the free atmosphere, all this making it necessary to install flexible skirts at the inlet of the chamber to avoid the passage of air;
a second chamber also placed under a slight overpressure of steam under the same conditions, this chamber including the entire exchange area of lids and of filled receptacles between first, second and third and fourth carousels, the steam escaping from said second chamber only through the inlet of the lids in the tubular magazine and through the inlet of the first carousel and the outlet of the fourth, all this making it necessary to install flexible skirts at the inlet and at the outlet of said second chamber to avoid the passage of air, and to connect said second chamber to said first chamber hermetically with no possibility of air entering;
means for transferring the receptacles between the other means that guarantee the maintaining of the degassing and of the sterile state of the products and receptacles;
means for slowing down the entry of air into the chambers under superheated steam.

### BRIEF DESCRIPTION OF THE DRAWINGS

The invention will be better understood with the aid of the description, given below purely by way of explanation, of an embodiment of the invention, with reference to the figures in which:

FIG. 1 is the entire system of devices necessary for the implementation of the present invention;

FIG. 2 is a schematic view of the installation of carousels of the system of devices implementing the sequence of operations for sealing the receptacle according to the invention;

FIG. 3 represents a schematic view of the “filling head”, with the symbolic representation of the steam whirlwind or vortex induced by the operation thereof;

FIG. 4 is a schematic view of the “sealing head” which enables the lids to be placed on the container, the sealing thereof after rotary steam injection, the cold showering of the containers and the cooling thereof;

FIGS. 5 and 7 represent axial sections of the filling head presented in FIG. 3, with, respectively, the configuration with the induced steam whirlwind or vortex and the movement of the food;

FIGS. 6 and 8 represent axial sections of the sealing head presented in FIG. 4, in two angularly offset sectional planes;

FIGS. 9 and 11 represent a cross section and a diagram of the mandrel of the filling head presented in FIG. 3;

FIGS. 10 and 12 represent a cross section of the mandrel of the sealing head presented in FIG. 4, respectively in top and bottom position;

FIG. 13 represents the circulation of the steam in the mandrel of the filling head presented in FIG. 3;

FIG. 14 represents the annular ring of the sealing head presented in FIG. 4; and

FIG. 15 represents the circulation of the steam and of the iced water in the mandrel of the sealing head presented in FIG. 4.

### DETAILED DESCRIPTION OF EMBODIMENTS OF THE INVENTION

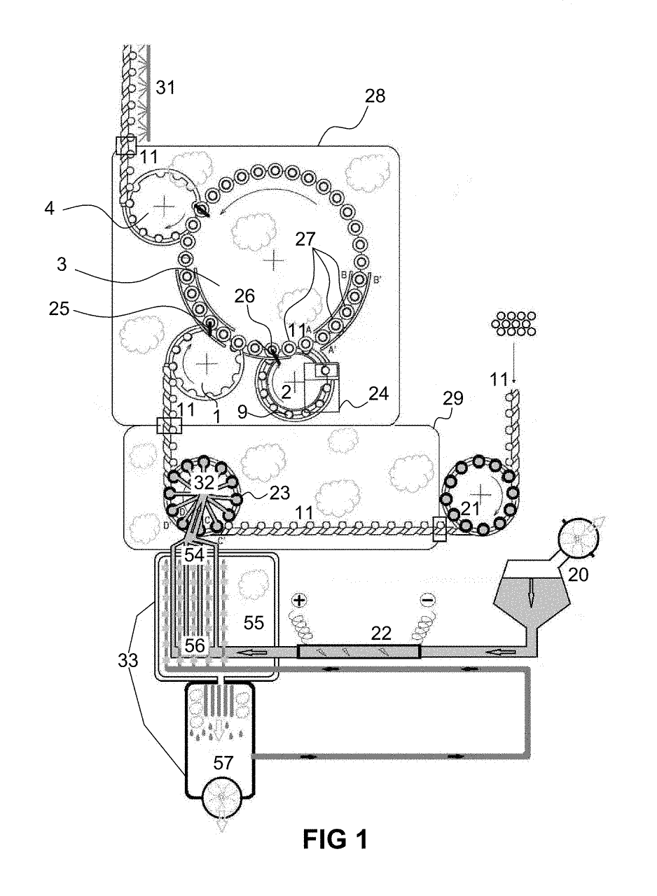

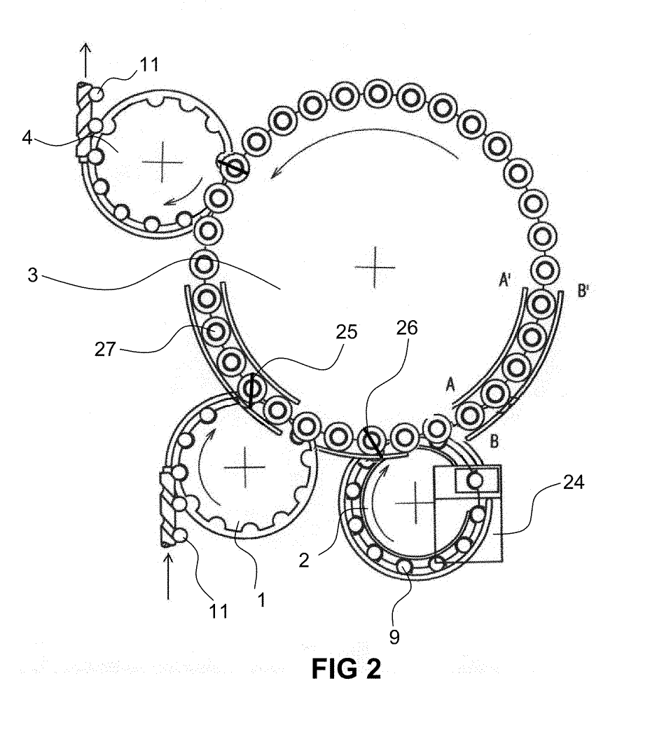

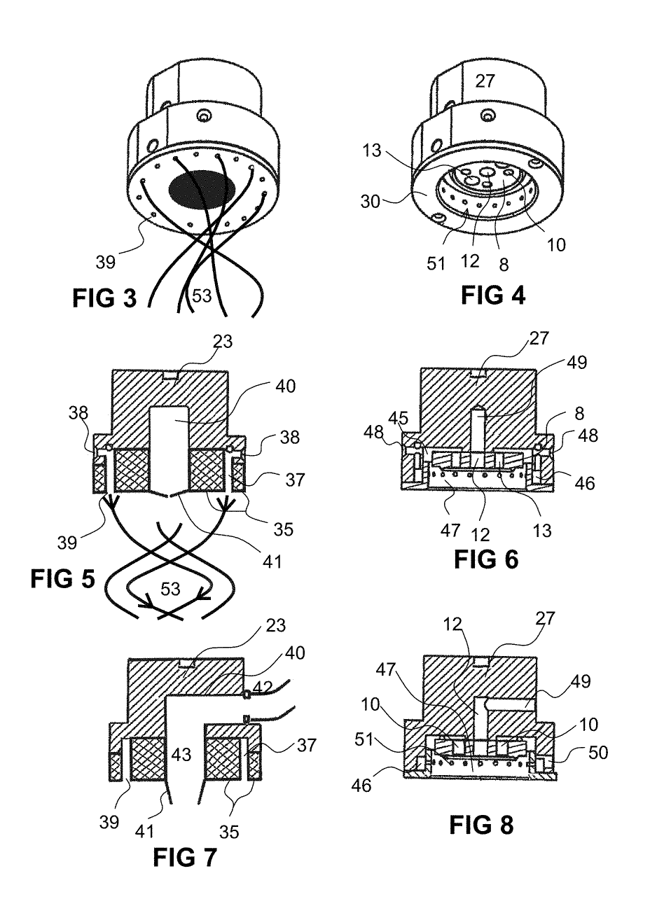

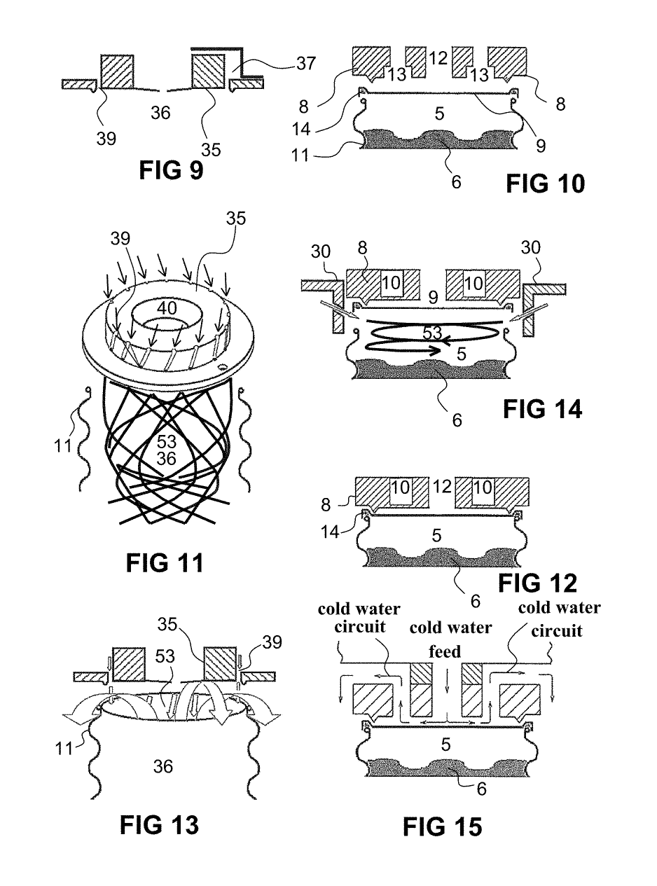

The devices (represented in FIG. 1) necessary for the implementation of the present invention are the following:
a first device 20 (FIG. 1) for degassing the products, this device being for example an evacuation system or a cooking system that naturally induces the degassing;
a device 21 (FIG. 1) for sterilizing, degassing and positioning the receptacles, this device using for example hydrogen peroxide, superheated steam or UV rays, said device leading, with no break in sterility or return of air into the receptacles, to a transfer line, optionally capable of turning over the receptacles if they have been introduced head down, said transfer line entering a separate chamber 29, contiguous to another chamber 28 where some of the operations take place;
a device 22 (FIG. 1) for sterilizing or pasteurizing the food. This device is composed of an ohmic tube or a heating tube with scraped surfaces, the latter being of the same type as those used in the tomato concentrate industry for all products to be pasteurized, or of any other system that would have made it possible to obtain a sterilization or a pasteurization of the product, all these systems necessarily being under pressure, the advantage of the ohmic tube being that it makes it possible to reduce the cooking time during the heating of the product while optimizing the sterilization time;
a cooling device 33 (FIG. 1) at the outlet of the sterilization only, intended to bring the product to the correct filling temperature as rapidly as possible, namely between 70° C. and 98° C. without making it lose its sterility, this device possibly being a multitube system, the tubes of which are immersed in a bath or under a cooling shower placed in a chamber at controlled pressure;
a filling head 23 (FIG. 1) optionally making it possible to complete the degassing and the sterilization of the receptacle, but above all enabling the measuring out and the sterile filling of the food in the receptacle from the device 22 connected by a sterile tubing system. The “filling head” is also represented as a figure (FIG. 3) in a form intended for aseptic hot filling, inducing a particular movement of the steam jets as a whirlwind or vortex, this being the only way to eliminate the residual air in the space in question, and comprising a product-dispensing circuit and a filling nozzle. The filling head 23 is installed in series on a filling line 32;
a device of carousels 1, 2, 3 (FIG. 1 and FIG. 2), the first carousel 1 making it possible to set the tempo of the delivery of the filled receptacles to the third carousel 3 while the second carousel 2 makes it possible to set the tempo of the delivery of the lids to the third carousel 3;
a device 24 (FIG. 1) for introducing, separating and disinfecting the lids 9 (FIG. 2) borne in series by the carousel 2 (FIG. 1 and FIG. 2), the device being supplied by a tubular magazine, this magazine being in fact placed in a stream of steam leaving the chamber 29;
a device 25 (FIG. 2) for transferring the receptacles filled with food from the first carousel 1 (FIG. 1 and FIG. 2) to the third carousel 3 (FIG. 1 and FIG. 2);
a device 26 (FIG. 2) for transferring the lids from the carousel 2 (FIG. 1 and FIG. 2) to the carousel 3 (FIG. 1 and FIG. 2);
a sealing head 27 (FIG. 1 and FIG. 2) that simultaneously enables the handling of the lids, the rotary injection of steam, the sealing of the receptacles filled with food and the cooling of the containers by cold showering, also represented in FIG. 4 in detail, said device being borne in series by a third carousel 3 (FIG. 1 and FIG. 2), said sealing head 27 comprising a mandrel 8 (FIG. 4) bearing magnetic means 10 (FIG. 4) said sealing head also comprising means for inducing a particular movement of the steam jets as a whirlwind or vortex, in order to eliminate the residual air in the space in question;
a carousel 4 (FIG. 1 and FIG. 2) for discharging the finally sealed receptacles to a cooling zone 31 (FIG. 1 and FIG. 2);
a chamber 28 (FIG. 1 and FIG. 2) maintained in a state of optimal sterility by the initial injection of superheated steam at the start of the process, then maintained under steam, all by any appropriate steam injection means, this chamber including the entire exchange area of lids and of filled receptacles between the carousels 1, 2, 3, 4 (FIG. 1 and HG 2), the steam escaping only upwards through the inlet of the lids in the tubular magazine of the device 24 and through the inlet and outlet located in the vicinity of the carousels 1 and 4 (FIGS. 1 and 2), these carousels 1 and 4 being entirely included in the chamber 28, flexible skirts placed at the inlet and at the outlet of the chamber 28 limiting the passage of air;
a chamber 29 (FIG. 1 and FIG. 2), located upstream of the entire vacuum sealing system and including the transfer line and the filling line 32, and therefore located just before the entry of the receptacles into the chamber 28, and being hermetically connected thereto, said chamber 29 being subjected, at the start of the process, to a stream of steam leaving the chamber 28 in order to purge it of its air, then also being placed under a slight pressure of superheated steam leaving therefore towards the free atmosphere at the device 21, flexible skirts at the inlet of the chamber 29 limiting the passage of air.

FIG. 3 represents in detail the “filling head” 23 (FIG. 1 and FIG. 2) which simultaneously enables optional additional degassing and disinfection of the receptacles and the sterile filling of the receptacles with the sterilized or pasteurized food.

The figure (FIG. 4) represents in detail the “sealing head” 27 (FIG. 1 and FIG. 2) which simultaneously enables the positioning of the lids on the container, the sealing thereof after rotary steam injection and the showering of the containers with cold water that induces a condensation in the container and the installation of an internal relative vacuum that guarantees the holding in place of the lid on the container. The filling head is characterized by a particular orientation of the steam injection nozzles that creates a whirlwind or vortex movement of steam in the receptacle, which movement ensures the complete discharging of the residual air.

With the aid of these diagrams, it is possible to better understand the complete process that characterizes the present invention and that takes place continuously according to the following steps as is described in FIGS. 1 and 2:
(a) the product is prepared in its sterile final state and it is degassed, either in a separate cooking operation, optionally under vacuum, or after cooking, continuously in a tubular installation with an endless screw, which installation is connected in series then to the pasteurizing or sterilizing system, either at the same time that the product is brought to temperature in a sterilizing or pasteurizing apparatus that may be either a heating tube with scraped surfaces or an ohmic tube or any other method that would make it possible to bring the product to be packaged to the correct filling temperature in a degassed state and cooked to the right degree, said degassing being necessary in order to further increase the vacuum level at the end of the process, the filling temperature possibly being from 90-92° C. for pasteurized products, which does not always require cooling, and below 98° C. for products that are already sterilized, the cooling between the sterilization outlet at 121° C. and the filling temperature having to be carried out as rapidly as possible in order to speed up the end of the cooking of the product, said cooling possibly being complete for an aseptic cold filling or partial for an aseptic hot filling;
(b) a first sterilization of the receptacles must take place before the loading thereof on the filling line 32 (FIG. 1), either with hydrogen peroxide, superheated steam or UV rays or a combination of these means, followed by an obligatory degassing, the latter having to take place by injection of superheated steam at more than 130° C. into the receptacles, this exposure to the superheated steam taking place in the free atmosphere, so that the air contained in the receptacles can escape outside of the packaging system, and said receptacles being presented with the opening downwards, so that the steam, which is lighter than air, has a tendency to remain in the receptacle,
(c) the empty receptacles then enter, full of steam and with the opening downwards, into the chamber 29 (FIG. 1) placed in a superheated steam atmosphere via a transfer line on which they are then turned over, with the opening upwards, then brought to the filling line 32 (FIG. 1) where they pass into the zone CC′-DD′ where a “filling head” 23 (FIG. 1 and FIG. 3, FIG. 5, FIG. 7) then drops onto each empty receptacle that arrives so as to leave a free space between said head 23 and the opening of the receptacle of around 5 to 10 mm and it is then that superheated steam, for example at 120-135° C., may optionally and additionally be injected into the receptacle by the injection device of the “filling head” 23, the injection being rotary by being carried out tangentially to the walls of the empty receptacle and at a slant, so as to create a powerful saturated steam whirlwind or vortex that ensures a complete elimination of the possible residual air in the receptacle, which is one solution for avoiding the possible trapping of air pockets in the product subsequently;
(d) using the “filling head” 23 (FIG. 1), the product is then measured out into the receptacles 11 (FIG. 1) on the filling line 32 (FIG. 1) located in the chamber 29 (FIG. 1),
(e) in the case of packaging pasteurized products, the product, which is already at the filling temperature, induces an additional pasteurization of the receptacle at 90° C.-92° C.;
(f) the filling stops when around the last centimetre of the receptacle is reached, so as to leave a sufficient space at the top of receptacle with no product, referred to as a “vacuum chamber” 5 (FIG. 12), representing around 10% of the height of the receptacle, in order to receive a sufficient amount of steam to subsequently guarantee a sufficient condensation and a deep vacuum;
(g) the receptacle filled with food and steam and therefore completely stripped of its air, then leaves the chamber 29 and enters the chamber 28 (FIG. 1) via a transfer line on the carousel 1 (FIG. 1 and FIG. 2);
(h) then said filled receptacle is transferred from carousel 1 to carousel 3 (FIG. 2) via a transfer mechanism 25 (FIG. 2) that brings it to a deposition base vertically centered under a sealing head 27 (FIG. 2 and FIG. 4, FIG. 6, FIG. 8);
(i) while the preceding tasks are carried out simultaneously, the lids 9 (FIG. 2) from a tubular dispensing magazine 24 (FIG. 2), after having been disinfected beforehand or being disinfected during the dispensing operation are separated and dispensed one by one on the second carousel 2 (FIG. 2) in such a way that only disinfected lids, the seal rubber of which may have optionally been softened by the steam as required, enter the chamber 28 (FIG. 1);
(j) the carousel 2 places the lids 9 one by one on the carousel 3 (FIG. 2) via a transfer mechanism 26 (FIG. 2), this taking place in the sterile chamber 28 in a superheated steam medium and each of these lids is deposited on a receptacle filled with food;
(k) on top of each receptacle covered with its lid is therefore a sealing head 27 (FIG. 2 and FIG. 4, FIG. 6, FIG. 8) in the raised position and possibly still containing traces of air that then undergoes a complete degassing by jet of superheated steam, by means of steam circuits integrated into said head 27, that open into the bottom portion of said sealing head 27;
(l) the receptacle filled with food and provided with its metal lid, which circulates at this moment on the carousel 3 (FIG. 2) in the chamber 28 is then pushed upwards by a piston and its neck is introduced into the dome that the sealing head 27 (FIG. 4) forms, which, under the action of its magnetic means 10 (FIG. 4), raises the lid that is then positioned on the mandrel 8 (FIG. 4), leaving a space having a height of 5 to 10 mm between the lid and the edge of the receptacle;
(m) as the receptacle passes into the zone AA′-BB′ of the carousel 3 (FIG. 2), superheated steam at 125° C. is then injected between the lid and the opening of the filled receptacle, by means of the steam injector nozzles distributed around the bottom portion of the sealing head 27 (FIG. 2 and FIG. 4, FIG. 6, FIG. 8), so as to create a whirlwind or vortex of superheated steam (FIG. 14) that ensures a complete elimination of the gases present between the lid and the product located in the receptacle and the replacement thereof with superheated steam;
(n) after injection of steam through the sealing head 27 (FIG. 2 and FIG. 4. FIG. 6, FIG. 8), the receptacle 11 and the lid are pressed against one another by a piston, bringing the flexible seal 14 (FIG. 12) of the lid 9 into contact with the rounded edge of the opening of the receptacle 11, this sealing making it possible to completely isolate the “vacuum chamber” 5 (FIG. 14) from the outside;
(o) caused by the same piston movement are the stopping of the steam injection and the opening via the valve 49 (FIG. 6) of the cold water circuit present in the sealing head 27,
(p) the sealing head 27 (FIG. 2) being supplied with cold water, this water flows over the mandrel 8 (FIG. 4) that bears the magnetic means which hold the lid 9, which mandrel is provided with at least one water inlet orifice 12 (FIG. 4) and with at least one lateral water outlet orifice 13 (FIG. 4), which makes it possible to flood the lid 9 (FIG. 14) with cold water and to carry out a first cooling that ensures the condensation of the steam located in the vacuum chamber 5 (FIG. 14), which then gives rise to a partial negative pressure in the container relative to the atmospheric pressure, said negative pressure being sufficient to guarantee that the receptacle and the lid are solidly joined;
(q) it is only then that the sealed container can optionally leave the chamber 28 (FIG. 1) and the cooling is continued by cold showering on the lid 9 (FIG. 14), the negative pressure brought about being sufficient to bring about a uniform boiling throughout the product, which boiling brings about a very rapid and uniform cooling throughout the product, the steam emitted by said boiling being condensed on the lid cooled by the cold showering, which makes it possible to discharge from the container 2269 kjoules per gramme of evaporated/condensed water or 542 kcal per gramme of evaporated/condensed water;
(r) the container under vacuum is then discharged to a cooling tunnel 31 (FIG. 1) via the carousel 4 (FIG. 1 and FIG. 2) were the same boiling and condensation phenomenon continues until the temperature has reached ambient temperature, the cold showering having to be continued as long as the temperature in the product has not dropped below the cooking temperature of the food lying at around 68° C., this drop in temperature being homogeneous in the product and taking place at least 3 times more quickly than in a conventional container without deep vacuum, for the 5 kg format, when the product has been suitably degassed at the start, and at least 6 times more quickly, for the case of the 1.3 kg drum format.

The process according to the invention may also be used to package, in sterile receptacles, a superclean product prepared from sterile ingredients and intended for distribution through the cold chain without pasteurization or sterilization, with aseptic cold filling, on condition that the product withstands, at the surface, flushing with superheated steam. In this case, the vacuum achieved depends on the initial degassing and on the steam injection conditions and it is not possible to count on the cooling of the product itself for further increasing the final vacuum. It is therefore necessary to enlarge the size of the vacuum chamber 5 (FIG. 12) in order to make the condensation greater and to increase the degassing and steam injection operations throughout the process without however damaging the product.

For the case of cold-packaged sterile products, it has been observed that the colder the product in the receptacle, the higher the steam flow rate should be.

After their sealing and their partial cooling by the sealing head 27 (FIG. 1), the filled jars or cans, now sealed by a hermetic lid, are then discharged by the carousel 4 (FIG. 1) and then move forward into a cooling tunnel 31 (FIG. 1). This cooling gives rise to an additional condensation in the sealed container and a rapid increase in the vacuum, homogeneously, in the container. This homogeneous pressure drop leads to a homogeneous boiling of the product at low temperature, the product being cooled very rapidly owing to this boiling which consumes 542 kcal/g of evaporated water contained in the product. The steam given off by this boning again increases the pressure slightly in the headspace, but said steam is immediately condensed again by contact with the lid onto which the cooling water of the tunnel runs, which inexorably recreates more vacuum.

The drop in temperature in the container is obtained much more rapidly than by heat conduction, the conventional process used in the industry, and this makes it possible to reduce the cooling time by 3 to 10 times compared to conventional packaging, depending on the size of the containers, with a homogeneous temperature drop in the container, for example from 95° C. to 68° C. in 4 minutes in a 1.3 kg drum when the vacuum is correctly achieved, which makes it possible to stop the cooking, unlike in the conventional cooling processes that leave the centre of the containers hotter and induce the caramelization of certain products.

After sufficient cooling, the jars or cans may pass through a drying tunnel on condition that the temperature of the blown air and the exposure time at this temperature do not cause reheating of the product and boiling at low temperature in the container. They are then ready for consolidation and over-packaging.

The presented invention improves the performance of the processes and system from the prior art, in the following manner:
by adding a prior product degassing phase;
by creating steam whirlwinds or vortices once during the sterilization of the containers, a second time in the receptacle just before filling and a third time just before sealing the receptacles in the space located between the lid and the product at the opening of the receptacle, these whirlwinds or vortices being enabled by a novel orientation of the nozzles downwards and tangentially with respect to the wall of the receptacle, which creates couples of forces capable of promoting the rotary descent of the steam in the spaces in question, and the total rotary escape of the air outside of the container, unlike all the methods in force in the food industry that only obtain a chaotic displacement of the air and therefore a partial degassing;
by completely describing the device systems for obtaining novel performances in terms of final vacuum in the container;
by reducing the heating and cooling times so as to minimize the cooking times without damaging the sterility of the products over time.

It is these first improvements that make it possible to gain around 30 to 100 mbar of vacuum after cooling and to lower the boiling temperature in the container by approximately 10° C. to 20° C., with, as a result, a more accelerated cooling for a further improved product quality, in particular for all the products containing fats sensitive to going rancid, which finally enables the packaging of purees in containers of bulk format (3 kg).

Moreover, the present invention adds to the preceding patent a system of devices that enables the sterile transfer between the sterilization/pasteurization means and the canning, which transfer has not been tackled in a complete manner in the preceding patents.

1-6. (canceled)

7. A process for a continuous deep-vacuum pasteurization or sterilization of food products in a rigid container, sealing of a receptacle portion of the container carried out by a metal lid of the rigid container free of a fastener and provided with an elastic seal to ensure a bond between a receptacle of the rigid container and the metal lid by a vacuum, comprising the steps of:
degassing of a ready-to-be-packaged food product;
pasteurization or sterilization of the food product;
cooling the food product to a filling temperature;
sterilization and degassing of receptacles, a first injection of a superheated steam in each receptacle, transferring the receptacles into a first chamber, with no break in sterility or introduction of non-condensable gases;
introducing the food product into the receptacles in the first chamber by measuring out and filling said each receptacle with the food product until a last centimetre of said each receptacle is reached, to leave a space having a sufficient volume so that a target vacuum is obtainable by a condensation of the superheated steam;
exit of the receptacles filled with the food product and the superheated steam from the first chamber and entry of the receptacles filled with the food product and the superheated steam into a separate second chamber, maintained under a superheated steam atmosphere, where the receptacles are positioned while waiting for their metal lids;
dispensing the metal lids from a tubular dispensing magazine into the second chamber, the metal lids being disinfected beforehand or during a dispensing operation, each metal lid is deposited on a receptacle filled with the food product and crosses a stream of superheated steam before exiting the second chamber towards a lid-dispensing magazine;
lifting said each metal lid from its receptacle by the lid-dispensing magazine to provide a second injection of the superheated steam between them;
pressing said each receptacle and its corresponding metal lid against one another to bring a flexible seal of the corresponding metal lid into a contact with a rounded edge of an opening of said each receptacle to completely isolate the space in said each receptacle from outside, the space being referred hereto as a vacuum chamber;
stopping the second injection of superheated steam and showering cold water onto the corresponding metal lid of said each receptacle to cool the corresponding metal lid and to ensure the condensation of the steam located in the vacuum chamber, which gives rise to a negative pressure in the rigid container of said each receptacle relative to an atmospheric pressure, the negative pressure being sufficient to solidly joined the corresponding metal lid to said each receptacle;
discharging each rigid container under vacuum to a cooling tunnel to further cool said each rigid container and showering cold water onto said each rigid container until a temperature of the food product in said each rigid container is below a cooking temperature of the food product; and
wherein the injections of the superheated steam, during the degassing steps, the filling step and the sealing step, are at more than 130° C. by imposing a rotary movement of whirlwind or vortex type on the superheated steam to eliminate a trace of air in a limited time, and the superheated stream, during the cooling and condensation thereof, causes the container to be placed under a deep vacuum, the superheated steam is injected at a temperature, at a flow rate and for a time to enable the sterilization of zones in question.

8. The process according to claim 7, wherein the cold water showering of said each rigid container is continued until a temperature of the food product in said each rigid container is below 68° C.

9. The process according to claim 7, further comprising a step of injecting the superheated steam into empty receptacles before the filling thereof with the food product to avoid trapping air bubbles below the food products during the filling thereof.

10. The process according to claim 7, further comprising a step of eliminating sources of non-condensable gases from the preparation of the food product up to the sealing of the containers, including the filling of the receptacles, to guarantee said deep vacuum in each of said containers.

11. The process according to claim 7, further comprising a step of continuously generating, in packaged containers, thermodynamic conditions so that all heat exchanges in the containers take place at a boiling point and a condensation point, thereby exploiting a latent heat of vaporization of water to discharge the heat from the containers.

12. The process according to claim 7 implements a homogeneous boiling of the food product, the homogeneous boiling being normal for materials containing water and placed under an envisaged vacuum, to continuously impose a homogeneous cooling of the food product in already sealed containers.

13. A vacuum sealing system for a continuous deep-vacuum pasteurization or sterilization of food products, comprising:
a degasser to degas a loose product;
a first sterilizer to sterilize and degas receptacles using at least a superheated steam as agent, the superheated steam inducing at least a complete degassing of inside of each receptacle;
a second sterilizer and a cooler to sterilize and cool the loose product, respectively, the cooler being placed at an outlet of the second sterilizer;
a tubular dispensing magazine to separate and disinfect lids, using the superheated steam as a disinfecting agent, the superheated steam inducing a degassing of surroundings of each lid, which contributes to a degassing of entire system;
a filling head to optionally discharge non-condensable gases in said each receptacle, and to measure out and sterile fill a food product into said each receptacle;
a sealing head to simultaneously handle the lids, inject the superheated steam, seal the receptacles filled with the food product, and cool the containers by cold showering, each container comprising a receptacle and a corresponding lid;
a first chamber comprising first, second, third and fourth carousels, the first chamber is maintained in a state of optimal sterility by an initial injection of superheated steam at a start of the continuous deep-vacuum pasteurization or sterilization process and the first chamber, including an entire exchange area of the lids and filled receptacles between the first, second, third and fourth carousels, are maintained under the superheated steam, the superheated steam escaping only upwards through an inlet of the lids in the tubular dispensing magazine and through inlet and outlet of the first and fourth carousels;
a second chamber comprising a filling line, the first chamber is located before an entry into the first chamber and upstream of other components of the vacuum sealing system, the second chamber is hermetically connected to the first chamber to prevent an entry of air and the second chamber is under an overpressure of the superheated steam;
a conveyor to transfer the receptacles between components of the vacuum sealing system that maintains a degassing and sterile state of the food products and the receptacles;
flexible skirts placed at ends of the first and second chambers to slow down the entry of air into the first and second chambers under the superheated steam; and
wherein the filling head comprises nozzles and the filling is configured to generate steam whirlwinds or vortices by orienting the nozzles downward and tangentially with respect to a wall of each receptacle on three occasions: during the sterilization of the containers, just before the filling of the receptacles, and before the sealing of the receptacles.

14. The system of claim 13, wherein the degasser is an evacuation system, a cooking system that naturally induces degassing, or a vacuum cooking system.

15. The system of claim 13, wherein the filling head is installed in series on the filling line.
